(19) United States
(12) Patent Application Publication
(10) Pub. No.: US 2026/0359340 A1
(43) Pub. Date: Nov. 12, 2026

(54) MACHINE-LEARNING CLASSIFICATION AND ASSEMBLY OF VEHICLE-TRANSACTION DOCUMENTS INTO A STRUCTURED DEAL JACKET

(71) Applicant: Ethos Group, Inc., Irving, TX (US)

(72) Inventors: Timothy Doyle Scrivner, Lewisville, TX (US); Preston Jabin Henninger, Trophy Club, TX (US); Jonathan Stuart Larman, Grapevine, TX (US)

(73) Assignee: Ethos Group, Inc., Irving, TX (US)

(21) Appl. No.: 19/749,336

(22) Filed: Jul. 21, 2026

Related U.S. Application Data
(63) Continuation of application No. 19/199,281, filed on May 5, 2025.

(51) Int. Cl. G06F 16/35; G06F 16/334

(52) U.S. Cl. CPC G06F 16/35; G06F 16/3347

(57) ABSTRACT

A system includes a known words algorithm configured to assign first document category votes to a set of input documents based on a first similarity between words in each input document and a set of known words, a machine-learning architecture configured to assign second document category votes to a subset of the set of input documents based on a second similarity between features of the subset and features of a set of known documents, and a voting monitor configured to, for each document in the set of documents, compare the first document category votes to a predetermined threshold and, in response to the first document category votes exceeding the predetermined threshold, assign a corresponding document category to the document and remove the document from the subset of the set of input documents.

### CROSS-REFERENCE TO RELATED PATENT APPLICATIONS

This application is a Continuation of U.S. Patent Application No.: 19/199,281, filed May 5, 2025, and titled "MACHINE-LEARNING DOCUMENT CATEGORIZATION SYSTEM WITH MULTI-STAGE VOTING," the entire disclosure of which is hereby incorporated by reference herein.

### FIELD

The present disclosure relates to document processing systems, and more particularly to a machine-learning-based document categorization system utilizing a multi-stage voting mechanism for efficient and accurate document identification.

### BACKGROUND

Document processing systems have become increasingly important in various industries for managing and organizing large volumes of information. These systems often face challenges in accurately categorizing and identifying different types of documents, particularly when dealing with diverse formats and content. Machine-learning techniques have emerged as a promising approach to improve document classification accuracy and efficiency.

However, existing document processing systems may struggle with complex or ambiguous documents that do not fit neatly into predefined categories. Additionally, the computational resources required for sophisticated machine-learning models can be substantial, potentially limiting their practical implementation in some environments.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a block diagram of an example document processing system.

FIG. 2 illustrates components of the document processing system of FIG. 1 for training a lighter ML architecture.

FIG. 3 is a block diagram of an example document processing system.

FIG. 4 illustrates operations of an example method for processing and categorizing documents.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

The document processing system described herein provides an efficient and flexible approach for categorizing and organizing input documents. This system employs a combination of algorithms and machine-learning techniques to analyze and classify documents based on their content and characteristics. The document processing system may include a known words algorithm, a machine-learning architecture, and a voting monitor. The known words algorithm may analyze the textual content of documents, while the machine-learning architecture may employ more sophisticated techniques to identify document features and patterns.

The document processing system may implement a funnel structure, incorporating multiple processing steps arranged in a sequence. This funnel structure may allow for a progressive refinement of document categorization, with each step potentially contributing to the overall classification process. In some cases, the system may be configured to add or remove processing steps within this funnel structure, providing flexibility to adapt to different document processing requirements or to incorporate new analysis techniques as they become available. In an example, the funnel structure includes the known words algorithm and the machine-learning architecture, where documents are provided to the known words algorithm first, and then provided to the machine-learning architecture if not successfully classified by the known words algorithm.

A voting mechanism may be employed within the document processing system to evaluate the results from various processing steps and enforce the funnel structure by filtering documents out of the funnel structure. This voting approach may allow the system to make classification decisions at several stages of the processing funnel. The voting approach allows for documents that have been successfully classified to be removed (i.e., filtered) from the processing funnel, providing for efficient processing of documents. The voting mechanism can evaluate classification determinations indicated by votes at each stage of the processing funnel to determine when documents are successfully classified (e.g., with a confidence above a predetermined threshold) and thus when the documents can be removed from the processing funnel. In this way, documents are classified using progressively more complex and computationally expensive methods until the documents are classified, conserving time and computational resources. This conservation of time and computational resources represents an improvement to the field of document classification using machine-learning models, as the voting monitor ensures that only the stages of the processing funnel that are necessary to classify a document are executed in classifying the document. Moreover, the specific implementation of the voting monitor to count votes assigned by different stages of the processing funnel represents a specific way to achieve the goal of efficient document classification, providing a specific mechanism and process for ensuring that only the stages of the processing funnel that are necessary to classify a document are executed in classifying the document.

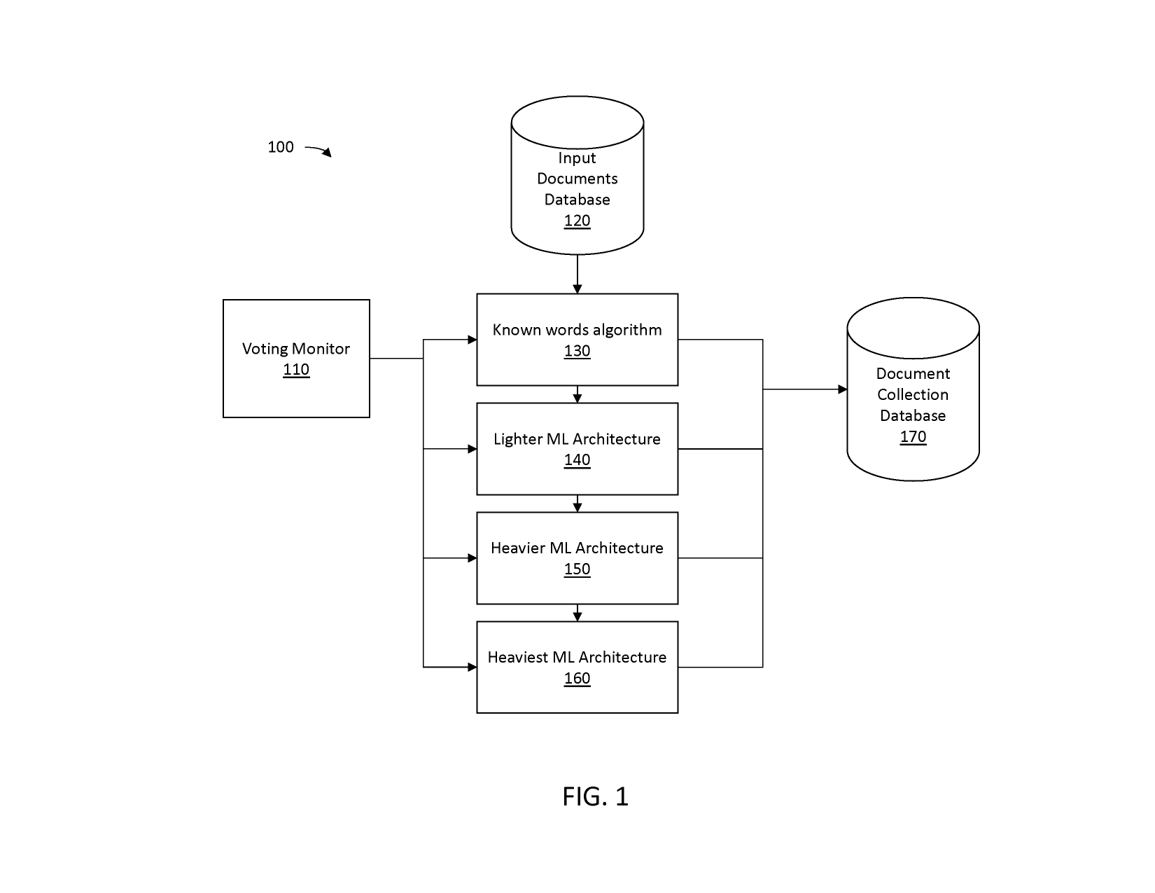

FIG. 1 illustrates a block diagram of an example document processing system 100. The document processing system 100 may include multiple components working together to analyze and categorize input documents. The document processing system 100 includes a voting monitor 110, an input documents database 120, a known words algorithm 130, a lighter ML architecture 140, and a document collection database 170. In some implementations, the document processing system 100 includes a heavier ML architecture 150 and/or a heaviest ML architecture 160.

The input documents database 120 may store a set of input documents for processing. These input documents may be analyzed and categorized by the various components of the document processing system 100. The known words algorithm 130, the lighter ML architecture 140, the heavier ML architecture 150, and the heaviest ML architecture 160 may form a processing funnel within the document processing system 100. This processing funnel may be designed to progressively analyze and categorize documents using increasingly complex techniques. The processing funnel may function to classify documents from the input documents database 120 into known categories. The categories can correspond to specific documents, or document types. In an example, the category for a document is “Retail Installment Contract.” In some implementations, the classification of documents includes determining categories and sub-categories. In an example, the category for a document is “Financing Documents,” with a sub-category of “Retail Installment Contract.” The result of this classification process may be a data structure, such as a packet of documents, which may be stored in the document collection database 170. The voting monitor 110 monitors classification votes at each stage of the processing funnel to determine when documents are successfully classified (e.g., a confidence for the classification is above a predetermined threshold) in order to remove the classified documents from the processing funnel and conserve time and computing resources that would be used by later stages of the processing funnel. In an example, the voting monitor 110 removes a document from the processing funnel based on the known words algorithm 130 classifying the document with a confidence above a predetermined threshold.

Each subsequent stage of the processing funnel is more computationally expensive and is able to classify documents with greater sophistication than earlier stages of the processing funnel. In some cases, the known words algorithm 130 may be an algorithm that does not use machine-learning and may execute faster and use fewer computing resources than the lighter ML architecture 140. The lighter ML architecture 140 may use fewer computing resources than the heavier ML architecture 150, which in turn may use fewer computing resources than the heaviest ML architecture 160. This arrangement may allow for efficient processing of documents, with more computationally expensive stages being applied only when necessary.

The ML architectures (140, 150, 160) may incorporate various types of machine-learning models to analyze and categorize documents. The ML architectures may also be referred to as machine-learning algorithms, or algorithms. In some implementations, the lighter ML architecture 140 may utilize simpler models such as logistic regression or decision trees, which can provide efficient processing for basic document classification tasks. The heavier ML architecture 150 may employ more sophisticated models like random forests or support vector machines, which may offer improved accuracy for complex document categorization scenarios.

In some cases, the heaviest ML architecture 160 may implement advanced deep learning models, such as convolutional neural networks (CNNs) or recurrent neural networks (RNNs). These models may be particularly effective for analyzing documents with rich visual content or complex sequential information. For instance, CNNs may be used to process document images and extract relevant features, while RNNs may be applied to analyze the sequential nature of text within documents. The heaviest ML architecture 160 may also incorporate natural language processing (NLP) models in various stages of the processing funnel. These may include transformer-based models like BERT (Bidirectional Encoder Representations from Transformers) or GPT (Generative Pre-trained Transformer), which can provide sophisticated text analysis capabilities.

In some implementations, the document processing system 100 provides different packages with varying levels of ML model complexity for different clients. For example, some implementations of the system may not include the heaviest ML architecture 160 and/or the heavier ML architecture 150, allowing for customization based on client needs and computational resources.

The input documents database 120 stores a set of documents to be classified by the document processing system 100. In some cases, the input documents database 120 may include various types of documents, such as text files, images, or scanned documents, which are awaiting processing and categorization. The input documents database 120 may serve as the initial repository for documents entering the document processing system 100. The input documents database 120 may interface with other components of the document processing system 100, such as the known words algorithm 130 and the lighter ML architecture 140. Documents can be retrieved from the input documents database 120 by a first stage in the processing funnel. In an example, the known words algorithm 130 retrieves or otherwise receives documents from the input documents database 120. In an example, the lighter ML architecture 140 is the first stage in the processing funnel and the lighter ML architecture 140 retrieves or otherwise receives documents from the input documents database 120. As documents are processed and categorized, the input documents database 120 may be updated to reflect the progress of document classification within the system.

The known words algorithm 130 may assign first document category votes to input documents based on similarities between words in the input documents and a set of known words. In some cases, the known words algorithm 130 employs a branched structure, such as a graph data structure, to efficiently determine these similarities. The branched structure used by the known words algorithm 130 may allow for efficient traversal and comparison of words and phrases. This structure may enable the algorithm to quickly identify relevant known words and calculate similarities, even when dealing with large sets of input documents and known words. The known words algorithm 130 may determine similarities between the words in the input documents and a set of known words correlated with various document categories.

In some implementations, the known words algorithm 130 may be particularly effective for categorizing documents related to vehicle sales. For example, the algorithm may utilize a set of known words correlated with different types of documents commonly involved in vehicle transactions. The known words algorithm 130 may associate terms like "VIN," "make," "model," and "year" with vehicle identification documents. Words such as "odometer," "mileage," and "condition" may be correlated with vehicle inspection reports. For financing documents, the algorithm may look for terms like "APR," "down payment," "monthly installment," and "loan term." In the case of warranty documents, the known words algorithm 130 may identify words like "coverage," "deductible," and "exclusions." Bill of sale documents may be correlated with terms such as "buyer," "seller," "purchase price," and "as-is." Insurance-related documents may be associated with words like "policy," "premium," "liability," and "comprehensive coverage." The algorithm may also recognize state-specific terms for registration documents, such as "title transfer," "plates," or "registration fee." For trade-in related documents, words like "trade-in value," "appraisal," and "negative equity" may be relevant.

By analyzing the number of known words within input documents and the correlations between the known words and document categories, the known words algorithm 130 may assign confidence scores and votes to different document categories. The known words algorithm 130 may assign votes to document categories based on a weighted count of known words correlated with each category, where the weighting may take into account factors such as word frequency, uniqueness, or relevance to the specific document type. In an example, this process may allow for efficient initial categorization of car sale documents, potentially reducing the workload for subsequent stages in the document processing funnel. The known words algorithm 130 may generate a confidence score for each input document.

The known words algorithm 130 assigns first document category votes (i.e., classification votes) to input documents based on these confidence scores. The number of votes assigned may be proportional to the confidence scores, with higher confidence scores resulting in more votes for a particular category. In some implementations, the known words algorithm 130 assigns a predetermined number of votes to each input document, with the predetermined number of votes allocated to each document category according to the confidence score for each document category. In an example, the known words algorithm 130 has one hundred votes to assign to each input document, with the number of votes allocated to each document category proportional to the confidence scores calculated for that document.

By leveraging these techniques, the known words algorithm 130 may provide an initial classification for input documents, assigning votes that can be used by the voting monitor 110 to determine whether a document has been successfully categorized or requires further processing by subsequent stages of the document processing system 100. The voting monitor 110 may evaluate the votes assigned by the known words algorithm 130 to determine if an input document has been successfully classified. In cases where the votes for a particular document category exceed a predetermined threshold, the voting monitor 110 may remove the corresponding input document from the processing funnel, preventing unnecessary further analysis by subsequent stages. This removal process may help optimize system resources by focusing computational efforts on documents that require more sophisticated analysis, while allowing confidently classified documents to bypass additional processing steps.

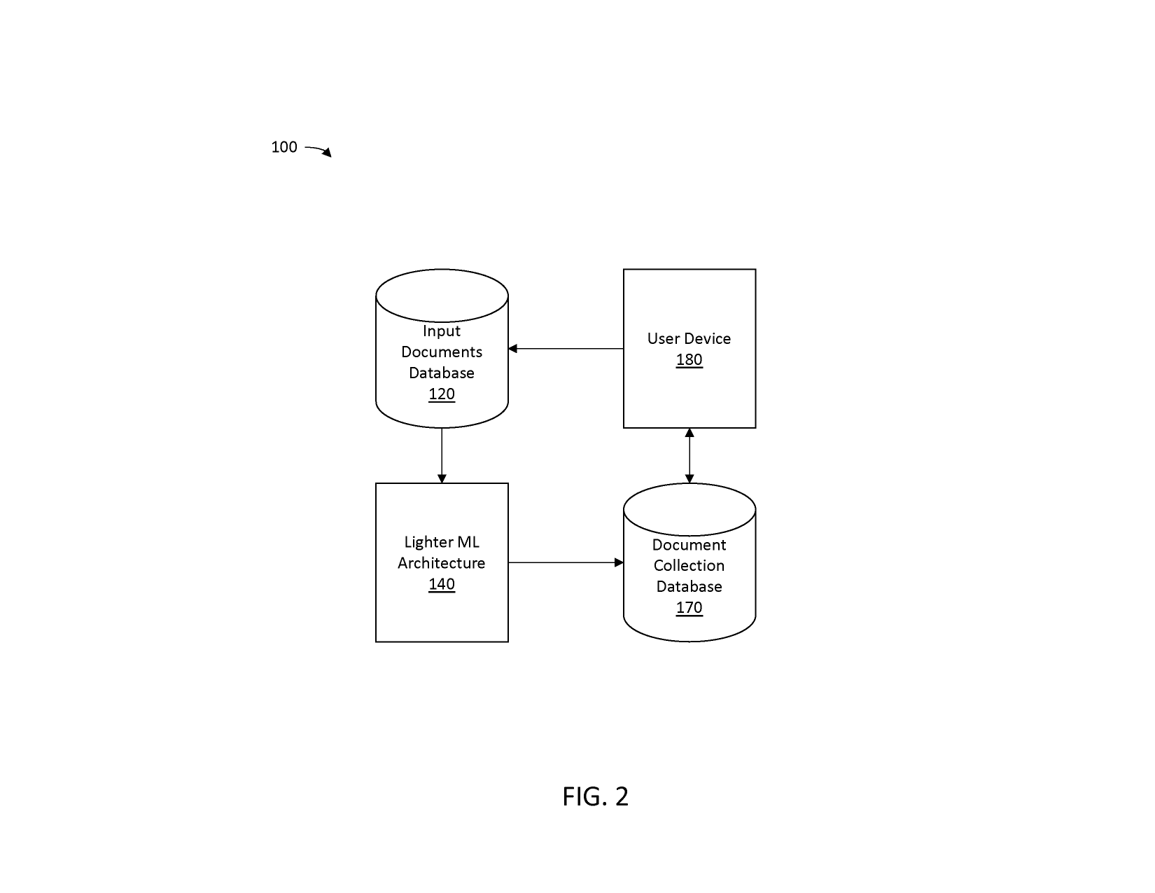

The lighter ML architecture 140 assigns second document category votes (i.e., classification votes) to a subset of input documents that were not successfully classified by the known words algorithm 130 and thus not removed from the processing funnel by the voting monitor 110. The lighter ML architecture 140 may analyze these documents based on similarities between features of the input documents and features of known documents correlated with various document categories. The training process for the lighter ML architecture 140 may involve a supervised learning approach for initial document type labeling. FIG. 2 illustrates components of the document processing system 100 involved in training the lighter ML architecture 140.

The lighter ML architecture 140 may begin by extracting features from the input documents. This feature extraction may involve generating tokens for each input document. These tokens may represent individual words or phrases within the document. In some implementations, the lighter ML architecture 140 may apply weights to the words or tokens for each input document based on their appearance in other input documents within the set of input documents. Words that are unique to a particular document, meaning they do not appear in other input documents, may be given greater weight. This weighting can allow the lighter ML architecture 140 to identify distinctive characteristics of each document. In some cases, the lighter ML architecture 140 may employ an inverse document frequency technique to determine confidence scores for each document category. This approach may consider the frequency of words across the set of input documents, potentially helping to identify distinctive terms that are more indicative of specific document categories.

The lighter ML architecture 140 may implement a pipeline that employs progressively more sophisticated and computationally expensive processes. The lighter ML architecture 140 may utilize n-grams in its processing pipeline, considering sequences of up to four consecutive words (4-grams). By analyzing these word sequences, or combinations of words, the lighter ML architecture 140 may identify patterns or phrases that are characteristic of particular document types. Using progressively large tokens may allow the architecture to capture more context and potentially improve its classification accuracy while conserving resources when larger tokens are not needed. In cases where the lighter ML architecture 140 produces low confidence scores for an input document (e.g., when the confidence vector does not include any scores above a predetermined threshold), the lighter ML architecture 140 may employ additional techniques, such as generating larger (i.e., higher n-gram) tokens. In an example, the lighter ML architecture 140 generates unigram tokens for an input document and generates a unigram confidence vector using unigram similarities. In this example, in response to the unigram confidence vector not including a confidence score above a predetermined threshold, the lighter ML architecture 140 generates bi-gram tokens for the input document and calculates additional similarities between the bi-grams of the input document and bi-grams of known words correlated with document categories to generate a bi-gram confidence vector. In this example, the lighter ML architecture 140 can continue to generate 3-gram and 4-gram tokens and corresponding confidence vectors, as needed. This approach may help to capture more context and potentially improve classification accuracy for challenging documents. By reserving higher-gram token generation and higher-gram confidence vector generation for input documents where the initial confidence scores do not indicate high confidence, the lighter ML architecture 140 conserves processing resources to efficiently categorize the input documents.

In some implementations, the lighter ML architecture 140 generates page-based bigrams to improve classification accuracy. Page-based bigrams are bigrams capturing features of pairs of pages. The lighter ML architecture 140 may generate page-based bigrams for training data, or known documents, and page-based bigrams for the input documents to calculate similarities between the page-based bigrams of the known, labeled documents and the page-based bigrams of the input documents. The page-based bigrams may improve classification accuracy based on neighboring documents being related. In an example, a first document may include few words and a second, neighboring document that is related to the first document may include more words, such that the lighter ML architecture 140 generates low confidence scores for classifying the first document and higher confidence scores for classifying the second document. In this example, by combining the first document and the second document to generate a page-based bigram, the lighter ML architecture may improve classification accuracy based on the combination of the first document and the second document due to the greater amount of information in the second document to generate higher confidence scores for the pair of the first document and the second document and thus to classify the first document with higher confidence. The lighter ML architecture 140 may generate page-based bigrams as well as higher order page-based grams. The lighter ML architecture 140 may implement progressively larger tokens to improve classification accuracy for documents that are difficult to classify, or which are not classified using smaller tokens. In some implementations, the lighter ML architecture 140 may generate higher-order word grams and then generate page-based grams to classify a document if the higher-order word grams do not result in successful classification.

Additionally, by implementing a pipeline of processes for classifying the input documents, the lighter ML architecture 140 provides explainability for its classifications. Confidence scores generated throughout the pipeline can indicate reasoning behind the classifications generated by the lighter ML architecture 140. In an example, confidence vectors for unigram, bi-gram, and 3-gram tokens can be analyzed to explain a classification made by the lighter ML architecture 140.

The lighter ML architecture 140 uses the confidence scores it generated to determine the number of second document category votes to assign to each input document. Documents with higher confidence scores for a particular category may receive more votes for that category. In some implementations, the lighter ML architecture 140 may assign a predetermined number of votes to each input document, similar to the approach used by the known words algorithm 130. For example, the lighter ML architecture 140 may have a total of 100 votes to allocate for each input document. These votes may be distributed among different document categories based on the confidence scores generated by the lighter ML architecture 140. Documents with higher confidence scores for a particular category may receive a larger portion of the predetermined vote allocation.

The voting monitor 110 may count (i.e., monitor, evaluate) the second document category votes assigned by the lighter ML architecture 140 to determine if an input document has been successfully classified by the lighter ML architecture 140. In cases where the votes for a particular document category exceed a predetermined threshold, the voting monitor 110 may remove the corresponding input document from the processing funnel, preventing unnecessary further analysis by subsequent stages. This removal process may help optimize system resources by focusing computational efforts on documents that require more sophisticated analysis, while allowing confidently classified documents to bypass additional processing steps. The voting monitor 110 may compare the number of second document category votes assigned to each input document against a predetermined threshold specific to the lighter ML architecture 140, or the same threshold used for the known words algorithm 130. In some implementations, the threshold applied to the second document category votes generated by the lighter ML architecture 140 is different from the threshold applied to the first document category votes generated by the known words algorithm 130 to account for a difference in confidence scores generated by the lighter ML architecture 140 and the known words algorithm 130. In some implementations, the voting monitor 110 may employ a dynamic thresholding mechanism that adjusts thresholds based on the overall distribution of votes across different document categories. This approach may allow the system to adapt to varying levels of classification confidence across different types of documents.

For input documents that receive votes exceeding the threshold for a particular category, the voting monitor 110 may tag these documents with the corresponding category label and remove them from the subset of documents proceeding to the next stage of the processing funnel. These successfully classified documents may be stored in the document collection database 170, along with their associated metadata and classification information. In cases where an input document does not receive enough votes to exceed the threshold for any category, the voting monitor 110 may allow that document to proceed to the next stage of the processing funnel for further analysis. This progressive filtering approach may ensure that documents requiring more complex analysis receive the necessary processing while efficiently categorizing documents that can be confidently classified at earlier stages. This progressive filtering approach based on comparison of numbers of votes for categories to predetermined thresholds represents a technical solution to the problem of document classification using complex machine-learning models. By applying lighter, less computationally expensive algorithms and machine-learning models first, and removing (i.e., filtering out) documents once they are successfully classified, the voting monitor 110 enforces execution of only those algorithms or machine-learning models that are needed for classification of each document. In this way, the progressive filtering approach improves the functioning of a computer used to classify the input documents by causing the computer to execute only those algorithms and/or machine-learning models necessary to classify each of the input documents.

The document processing system 100 may include additional components in the processing funnel to handle more complex or ambiguous documents that were not successfully classified by earlier stages. In some cases, the document processing system 100 may include the heavier ML architecture 150 and the heaviest ML architecture 160, as illustrated in FIG. 1. The heavier ML architecture 150 may assign third document category votes to a second subset of input documents that were not classified in earlier stages of the processing funnel. This second subset may include documents that did not receive sufficient votes from the known words algorithm 130 or the lighter ML architecture 140 to exceed the predetermined thresholds for classification.

In some cases, the heavier ML architecture 150 employs more sophisticated machine-learning models or techniques compared to the lighter ML architecture 140. These models may be capable of capturing more nuanced features or relationships within the documents, potentially improving classification accuracy for complex cases. The heavier ML architecture 150 may utilize advanced machine-learning techniques such as ensemble methods to improve classification accuracy for complex documents. In some implementations, the heavier ML architecture 150 employs a Random Forest classifier, which combines multiple decision trees to make predictions. This ensemble approach may allow the system to capture intricate relationships between document features that simpler models might miss. For example, the heavier ML architecture 150 may create a Random Forest model using a large number of decision trees, each trained on a random subset of the input features. When classifying a document, each tree in the forest may vote for a particular category based on the document's features. The final classification may be determined by aggregating these votes across all trees in the forest. In some cases, the Random Forest classifier in the heavier ML architecture 150 may incorporate feature importance analysis. This technique may help identify which document characteristics are most influential in determining the document category. By focusing on these key features, the heavier ML architecture 150 may improve its classification accuracy and provide insights into the decision-making process. The heavier ML architecture 150 may also implement boosting algorithms, such as XGBoost or LightGBM, which iteratively build a series of weak learners to create a strong classifier. These algorithms may adaptively focus on difficult-to-classify documents, potentially improving performance on complex cases that were not successfully categorized by earlier stages in the processing funnel.

The heaviest ML architecture 160 may assign fourth document category votes to a third subset of input documents that were not classified by the heavier ML architecture 150 and other earlier stages in the processing funnel. This third subset may represent the most challenging documents to categorize, requiring the most advanced analysis techniques available in the document processing system 100. The heaviest ML architecture 160 may implement advanced deep learning models, such as computer vision models, convolutional neural networks (CNNs), and/or recurrent neural networks (RNNs). These models may be particularly effective for analyzing documents with rich visual content or complex sequential information. For instance, CNNs may be used to process document images and extract relevant features, while RNNs may be applied to analyze the sequential nature of text within documents. The system may also incorporate natural language processing (NLP) models in various stages of the processing funnel. These may include transformer-based models like BERT (Bidirectional Encoder Representations from Transformers) or GPT (Generative Pre-trained Transformer), which can provide sophisticated text analysis capabilities. In some implementations, the heaviest ML architecture 160 may utilize attention mechanisms to focus on the most relevant parts of input documents. This approach may allow the system to handle long documents more effectively by prioritizing important sections or features.

The voting monitor 110 may continue to evaluate the votes assigned by the heavier ML architecture 150 and the heaviest ML architecture 160, applying appropriate thresholds to determine when documents have been successfully classified. Documents that receive sufficient votes from these later stages may be removed from the processing funnel and stored in the document collection database 170. In this way, the voting monitor 110 oversees the document categorization process within the document processing system 100. The voting monitor 110 manages votes assigned by different components of the system, including the known words algorithm 130, the lighter ML architecture 140, the heavier ML architecture 150, the heaviest ML architecture 160, and any other additional components, to identify when documents are successfully classified and remove the successfully classified documents from the processing funnel.

The voting monitor 110 may be configured to interrupt processing steps in the document processing system 100 based on vote counts. This interruption may occur when a document receives sufficient votes to be confidently categorized, allowing the system to bypass remaining processing stages for that document. By interrupting the processing funnel in this manner, the voting monitor 110 conserves computing resources and improves overall system efficiency.

In some implementations, the document processing system 100 may be designed to accommodate the addition of new components to the processing funnel. These new components may be integrated by generating configurations that translate between their outputs, such as confidence scores, and the classification votes used by the voting monitor 110. The configurations can represent a strategy for integrating outputs of the new components into the voting mechanism described herein. The configurations can be applied inline or can be implemented by an external component that translates the output of the components into votes. For example, a configuration may be created to map the confidence scores produced by a new machine-learning model to a predetermined number of votes, similar to the approach used by existing components. This configuration may include scaling factors, thresholds, or more complex algorithms to ensure the new component's output is compatible with the voting monitor 110. By implementing such configurations, the document processing system 100 may maintain its flexibility and adaptability, allowing for the incorporation of new analysis techniques or specialized components without requiring changes to the core voting and filtering mechanisms employed by the voting monitor 110. In some implementations, the voting monitor 110 references a configuration for a machine-learning architecture to translate the output (e.g., confidence scores) of the machine-learning architecture into document category votes.

The document collection database 170 may serve as a repository for processed and categorized documents within the document processing system 100. The document collection database 170 stores input documents that have been successfully classified by various components of the system, such as the known words algorithm 130, the lighter ML architecture 140, the heavier ML architecture 150, or the heaviest ML architecture 160. The classified documents may be organized into structured collections within the document collection database 170 based on their assigned categories. This process may involve tagging the document with its assigned category and placing it within a structured document collection according to that category. The tagging process may add metadata to the document, facilitating easier retrieval and organization within the database. In an example, the voting monitor 110 tags a document as a “vehicle maintenance report” and adds it to a packet of documents for a vehicle within a section for vehicle condition information. The document collection database 170 may include analysis results for the classified documents such as confidence scores, feature vectors, or other relevant data generated during the classification process. By storing this information alongside the documents, the document collection database 170 may enable more efficient retrieval and analysis of processed documents as well as explainability for the classifications of document.

In some implementations, the structured data format relates to vehicle sales with the different document categories corresponding to different aspects of vehicle sales. The structured data format may group together all documents associated with a single vehicle transaction, creating a comprehensive digital “deal jacket,” or “dealer record envelope.” For example, the structured data format may include a collection of documents such as the vehicle identification document, inspection report, financing agreement, warranty information, bill of sale, insurance verification, registration forms, and trade-in appraisal. Each document within this collection may be tagged with metadata indicating its category, confidence score from the classification process, and/or relevant extracted information like VIN number or sale price. This structured format may allow for efficient retrieval and analysis of entire vehicle sale transactions, enabling users to quickly access all relevant documents for a specific sale, compare data across multiple sales, or generate reports on dealership performance. The structured data format may also facilitate integration with other systems, such as inventory management or customer relationship management software, providing a holistic view of each vehicle sale transaction.

FIG. 2 illustrates components of the document processing system 100 involved in training the lighter ML architecture 140. The training approach may leverage user input and existing document collections to develop and refine classification capabilities of the lighter ML architecture 140. This process may involve several stages, including document labeling, feature extraction, and iterative model training, which may work together to enhance the system's ability to accurately categorize input documents. In some implementations, the lighter ML architecture 140 is trained using a supervised learning approach. This process may involve users uploading and manually labeling documents through the user device 180, with these labeled documents then being stored in the input documents database 120 for use in training the lighter ML architecture 140. The lighter ML architecture 140 can access these labeled documents to learn the characteristics and features associated with different document categories.

During the training process, the lighter ML architecture 140 may generate feature vectors for each input document and for known documents (i.e., labeled documents) associated with various categories. These feature vectors may represent the documents in a high-dimensional space, capturing various attributes such as word frequencies, n-gram patterns, and other relevant features. The lighter ML architecture 140 may compare the feature vectors of input documents with those of known documents (e.g., labeled documents) to determine similarities. This comparison may involve calculating cosine similarities or other similarity metrics between the feature vectors. Based on these similarities, the lighter ML architecture 140 may assign confidence scores to different document categories for each input document. In an example, the lighter ML architecture 140 uses a first subset of labeled documents as known documents and a second subset of the labeled documents as input documents in order to compare similarities between the input documents and the known documents, and to check the accuracy of the estimated categories of the input documents against their labels.

The lighter ML architecture 140 may be updated based on the differences between its generated classifications and the actual labeled ground truth (i.e., the user-provided labels). In some implementations, the system may employ a backpropagation algorithm to adjust the weights and parameters of the lighter ML architecture 140. This process may involve calculating the error between the predicted classifications and the true labels, then propagating this error backward through the network to update the model's parameters. The learning rate and other hyperparameters of the model may be fine-tuned during this process to optimize performance. In some cases, the system may utilize techniques such as gradient descent or its variants to iteratively refine the model's parameters, gradually improving its classification accuracy over multiple training epochs.

In some implementations, the lighter ML architecture 140 may be customized for each client based on their specific document types and classification needs. This customization may involve fine-tuning the model using client-specific training data, adjusting the feature extraction process to focus on relevant attributes for that client's documents, or modifying the model architecture to better handle the unique characteristics of the client's document set. By tailoring the lighter ML architecture 140 to each client, the document processing system 100 may achieve improved classification accuracy and efficiency for client-specific document types, while maintaining a lightweight and computationally efficient model.

In some implementations, the lighter ML architecture 140 may be trained to classify vehicle sale documents based on document categories specific to a particular car dealership. For example, a dealership may use unique categories such as "Vehicle Purchase Agreement," "Extended Warranty Offer," "Trade-In Valuation," and "Financing Application." The training process may involve dealership staff uploading and labeling sample documents through the user device 180. These labeled documents may be stored in the input documents database 120, allowing the lighter ML architecture 140 to learn the distinctive features and patterns associated with each category. The system may extract relevant features such as key phrases, document structure, and formatting elements typical of each document type used by the dealership. As the lighter ML architecture 140 processes more dealership-specific documents, it may refine its classification accuracy, potentially adapting to variations in document formats or content specific to that dealership's operations.

The lighter ML architecture 140 may be trained through an iterative process that initially requires user input for document labeling, but gradually reduces the need for manual intervention as the model's classification accuracy improves. As the lighter ML architecture 140 processes more documents and receives feedback on its classifications, it may learn to identify patterns and features autonomously, potentially allowing the system to estimate labels for new documents with increasing confidence and accuracy over time. This progressive learning approach may enable the system to become more self-sufficient in document classification, requiring user interaction primarily for edge cases or previously unseen document types.

In some implementations, other machine-learning models of the document processing system 100 may be trained in similar manner. In some implementations, the document processing system 100 is trained in an iterative manner, with different machine-learning models being trained when different amounts of training data is available. In some implementations, different machine-learning models are associated with different training data thresholds at which they are trained. In an example, a user begins labeling documents according to category until a first training data threshold is reached for the lighter ML architecture 140, at which point, the lighter ML architecture 140 is trained and begins classifying documents. In this example, the documents classified by the lighter ML architecture 140 may be added to the training data, or added to the training data after approval by the user. In this example, after the training data includes a number of documents (labeled by the user and classified by the lighter ML architecture 140) above a second training data threshold for the heavier ML architecture 150, the heavier ML architecture 150 is trained and begins classifying documents. In this example, after the training data includes a number of documents (labeled by the user and classified by the lighter ML architecture 140 and the heavier ML architecture) above a third training data threshold for the heaviest ML architecture 160, the heaviest ML architecture 160 is trained and begins classifying documents. Training data thresholds may be specific to each of the lighter ML architecture 140, the heavier ML architecture 150, and the heaviest ML architecture 160 and can be based on a quality of training data as well as a type of training data. In an example, the lighter ML architecture 140 may have a training data threshold of a predetermined number of comparable documents, such as a predetermined number of documents for each category.

In some implementations, the user device 180 may provide an interface for users to review and provide feedback on classifications generated by the lighter ML architecture 140. Users may be presented with the classified documents and their assigned categories, allowing them to confirm, reject, or modify the classifications through the user device 180. This feedback may be transmitted to the document collection database 170, where it can be stored alongside the original classification data. The system may then use this user-provided input to refine and improve the lighter ML architecture's 140 classification capabilities over time.

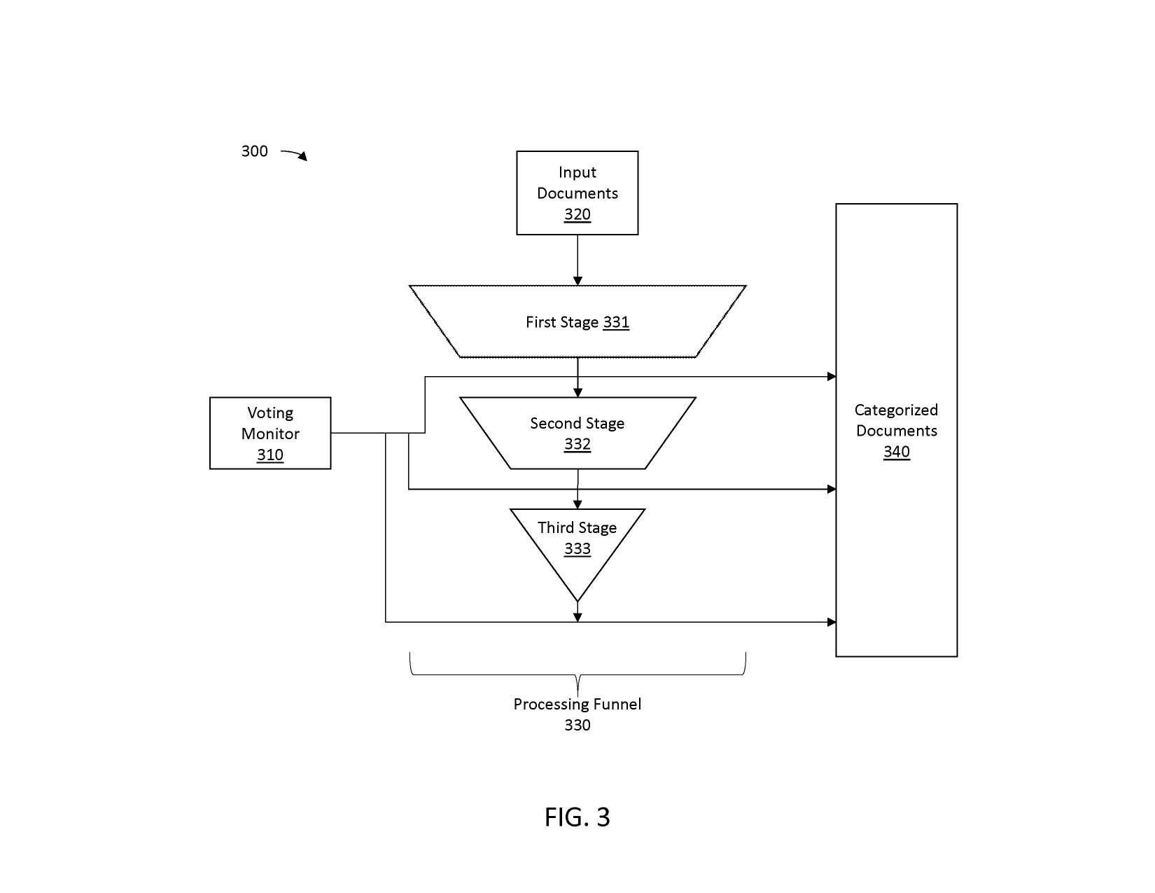

FIG. 3 is a block diagram of an example document processing system 300. The document processing system 300 can be similar to the document processing system 100 of FIG. 1. In some implementations, the document processing system 100 of FIG. 1 is an example of the document processing system 300.

The document processing system 300 include a processing funnel 330 including a first stage 331, a second stage 332, and a third stage 333. While the processing funnel 330 is illustrated as including three stages, the processing funnel 330 can include any number of stages. In an example, the processing funnel 330 includes the known words algorithm, the lighter ML architecture 140, the heavier ML architecture 150, and the heaviest ML architecture 160 of FIG. 1. The processing funnel categorizes (i.e., classifies) input documents 320 to generate categorized documents 340. Different stages of the processing funnel categorize different subsets of the input documents 320.

The first stage 331 processes, or categorizes the input documents 320 by assigning first votes to document categories for each input document of the input documents 320. A voting monitor 310 determines categories for the input documents 320 based on the assigned first votes. The voting monitor 310 determines whether a document is successfully classified after the first stage 331 or whether the document should proceed through the processing funnel 330 based on the assigned first votes. The voting monitor 310 compares the assigned first votes to a predetermined threshold to determine the category for each document and/or determine whether the document should proceed through the processing funnel 330. In an example, the first stage 331 assigns two votes to a first category, one vote to a second category, fifty-seven votes to a third category, and zero votes to a fourth category. In this example, the voting monitor 310 compares the assigned votes to a predetermined threshold of fifty votes, tags the document with the third category based on the fifty-seven votes assigned to the third category exceeding the threshold, and removes the document from the processing funnel to the categorized documents 340 based on the document being tagged with the third category.

A first subset of the input documents 320 not successfully categorized in the first stage 331 proceeds to the second stage 332. The second stage 332 processes, or categorizes the input documents by assigning second votes to document categories for each input document of the first subset of the input documents 320. The voting monitor 310 determines whether a document is successfully classified after the second stage 332 or whether the document should proceed through the processing funnel 330 based on the assigned second votes. Based on a number of the assigned second votes exceeding a predetermined threshold for the second stage 332, the voting monitor 310 tags the document with a category corresponding to the number of the assigned second votes exceeding the predetermined threshold and removes the document from the processing funnel to the categorized documents 340. In some implementations, the predetermined threshold for the second stage 332 is the same as the predetermined threshold for the first stage 331. In some implementations, the predetermined threshold for the second stage 332 is different from the predetermined threshold for the first stage 331.

In some implementations, the voting monitor 310 determines whether the document is successfully classified after the second stage 332 based on the assigned first votes assigned by the first stage 331 and the assigned second votes assigned by the second stage 332. In this way, the voting monitor 310 can determine the categorization of the document based on the cumulative categorization by the first stage 331 and the second stage 332. In an example, the first stage 331 assigns a number of first votes to a category that is less than the predetermined threshold for the first stage 331 and the second stage 332 assigns a number of second votes to the category that is less than the predetermined threshold for the second stage 332, but a combined number of the first votes and the second votes for the category is greater than a predetermined threshold for the second stage 332 for combined first votes and second votes. In this example, the voting monitor 310 tags the input document with the category and removes the document from the processing funnel 330 to the categorized documents 340.

A second subset of the input documents 320 not successfully categorized in the first stage 331 and the second stage 332 proceeds to the third stage 333. The third stage 333 processes, or categorizes the input documents by assigning third votes to document categories for each input document of the second subset of the input documents 320. The voting monitor 310 determines whether a document is successfully classified after the third stage 333 based on the assigned third votes. If the processing funnel 330 includes additional stages beyond the third stage 333, the voting monitor determines whether the document should proceed through the processing funnel 330 based on the assigned third votes. Based on a number of the assigned third votes exceeding a predetermined threshold for the third stage 333, the voting monitor 310 tags the document with a category corresponding to the number of the assigned third votes exceeding the predetermined threshold and removes the document from the processing funnel to the categorized documents 340. In some implementations, the predetermined threshold for the third stage 333 is the same as the predetermined threshold for the first stage 331 and/or the predetermined threshold for the second stage 332. In some implementations, the predetermined threshold for the third stage 333 is different from the predetermined threshold for the first stage 331 and/or the predetermined threshold for the second stage 332.

In some implementations, the voting monitor 310 determines a category for documents in the second subset based on the assigned third votes assigned by the third stage 333 and the assigned first votes assigned by the first stage 331 and/or the assigned second votes assigned by the second stage 332. In this way, the voting monitor 310 can determine the categorization of the document based on the cumulative categorization by the third stage 333 and one or more of the first stage 331 and the second stage 332. In an example, the first stage 331 assigns a number of first votes to a category that is less than the predetermined threshold for the first stage 331, the second stage 332 assigns a number of second votes to the category that is less than the predetermined threshold for the second stage 332, and the third stage 333 assigns a number of third votes to the category that is less than the predetermined threshold for the third stage 333, but a combined number of the first votes, the second votes, and the third votes for the category is greater than a predetermined threshold for the third stage 333 for combined first votes, second votes, and third votes. In this example, the voting monitor 310 tags the input document with the category and removes the document from the processing funnel 330 to the categorized documents 340. In this way, the voting monitor 310 can, at the end of the processing funnel 330, determine categories for the second subset of the input documents 320 based on the combined votes from the first stage 331, the second stage 332, and the third stage 333.

In some implementations, the voting monitor 310 determines that a document from the input documents 320 cannot be classified after being processed by the processing funnel 330. The voting monitor 310 can provide the unclassified document to a human reviewer. One or more stages of the processing funnel 330 can be updated or refined based on feedback from the human reviewer. Similarly, a human reviewer can give feedback on categorizations determined by the voting monitor 310 using the processing funnel 330 which is used to update or refine one or more stages of the processing funnel 330 and/or one or more thresholds used by the voting monitor 310. In this way, the document processing system 300 can learn from its mistakes and from new information.

In some implementations, the first stage 331 is less computationally expensive and/or faster than the second stage 332, which is less computationally expensive and/or faster than the third stage 333. In this way, the processing funnel 330 includes progressively more computationally expensive and/or time-demanding stages. The third stage 333 can be capable of processing more complicated documents than the second stage 332, which can be capable of processing more complicated documents than the first stage 331. In this way, the processing funnel 330 processes documents using progressively more capable, and progressively more computationally expensive stages.

In some implementations, the processing funnel 330 can be configured for specific use cases. The processing funnel 330 can have different combinations of algorithms and/or machine-learning models configured to process a specific type of documents. The processing funnel 330 can be configured to skip stages of the processing funnel based on a configuration of the processing funnel 330 and/or a type of documents being processed. In an example, the first stage 331 can be disabled for processing documents of a particular type that are generally not successfully classified by the first stage 331, conserving compute resources that would have been wasted in attempting to classify the documents using the first stage 331. In an example, the document processing system 300 causes documents with few words and thus few tokens to skip a stage of the processing funnel 330 based on the skipped stage having a low probability of successfully classifying documents with few tokens. In this way, the processing funnel 330 can be configured to more efficiently process documents based on the capabilities of different stages of the processing funnel 330 in classifying documents.

The processing funnel 330 can include one or more machine-learning models (also referred to as “machine-learning algorithms” or “algorithms” that are trained to classify documents. In some implementations, the processing funnel 330 can be trained to classify documents by training the one or more machine-learning models. The one or more machine-learning models can each be associated with a training data threshold representing an amount of training data for training the corresponding machine-learning model. As a user labels documents and as different stages of the processing funnel 330 classify documents to generate training data, additional stages of the processing funnel 330 can be trained and begin to classify documents. In this way, the processing funnel 330 can automatically begin classifying documents immediately, incorporating additional machine-learning stages as soon as sufficient training data is available. In an example, a user begins labeling documents to generate training data until one document per category is labeled corresponding to the training data threshold of the first stage 331, and then the first stage 331 is trained using the labeled documents and begins to classify and label documents to add to the training data. In this example, once the training data has been increased by the user and/or the first stage 331 to include three documents per category corresponding to the training data threshold of the second stage 332, the second stage 332 is trained and begins to classify and label documents. In this way, the processing funnel 330 can begin processing documents sooner, and with less training data than conventional systems, reducing an amount of manual labeling and decreasing a time to classify documents.

The document processing system 300 represents two technical solutions that improve the functioning of a computer in classifying documents. First, the voting monitor 310 removes documents from the processing funnel 330 after each stage, conserving computing resources and time that would be consumed by later stages of the processing funnel 330. Second, the voting monitor 310 removes documents from the processing funnel 330 as soon as the documents are successfully classified by a least-computationally expensive stage that can classify the document, multiplying the computational resources and time saved by skipping the later stages of the processing funnel. In this way, the voting monitor 310 improves the functioning of a computer that executes the processing funnel 330 to classify documents by causing the computer to execute only the stages of the processing funnel 330 necessary to classify each document of the input documents 320 to conserve time and processing resources of the computer.

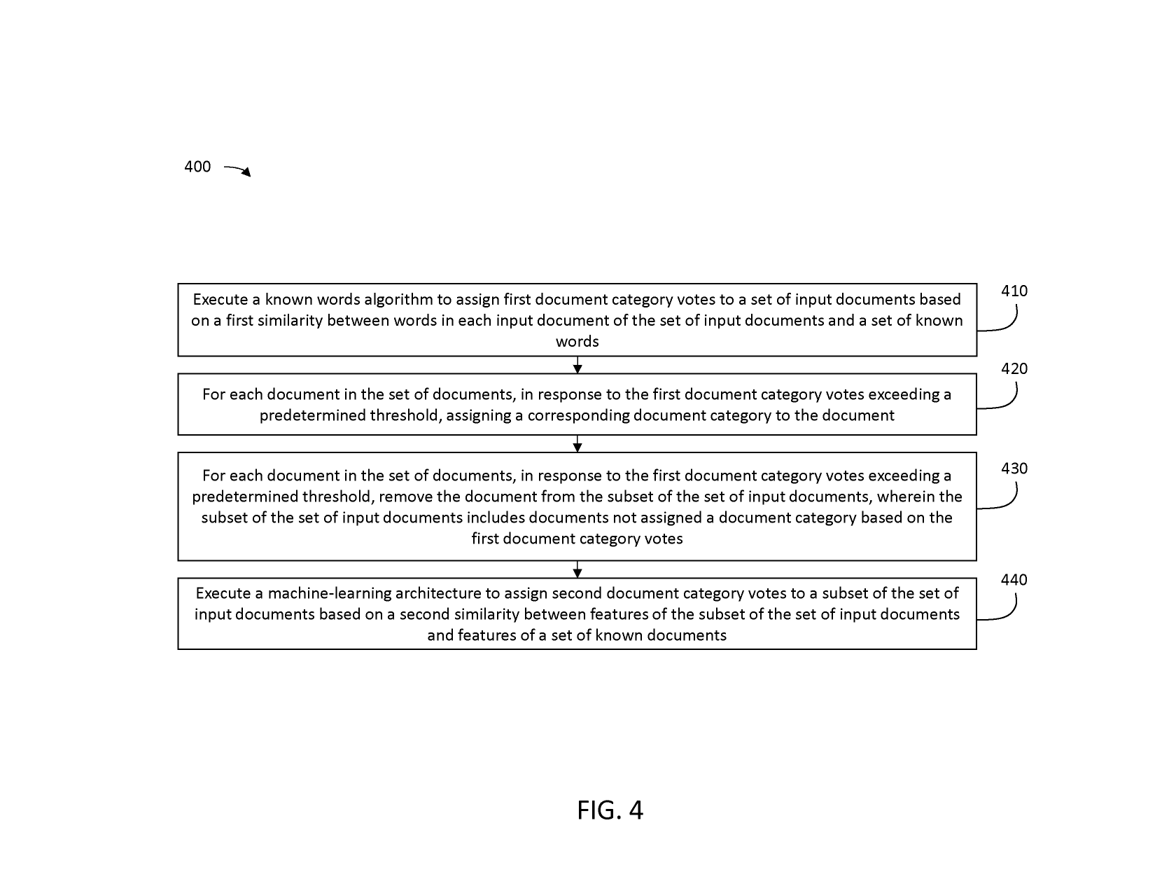

FIG. 4 illustrates a flowchart of a method 400 for processing and categorizing documents. The method 400 may include more, fewer, or different operations than shown. One or more operations can be performed in the order shown, in a different order, or concurrently. The method 400 can be performed by one or more components of the document processing system 100.

At operation 410, a known words algorithm is executed to assign first document category votes to a set of input documents. This assignment may be based on a first similarity between words in each input document of the set of input documents and a set of known words. The known words algorithm may apply weights to the words in each input document based on their appearance in other input documents within the set of input documents. Words that are unique to a particular document, meaning they do not appear in other input documents, may be given greater weight. This weighting approach may allow the known words algorithm to identify distinctive characteristics of each document, potentially improving the accuracy of the first document category votes assigned.

The known words algorithm may employ a branched structure, such as a tree or graph, to efficiently organize and search the set of known words. This structure may allow for rapid traversal and comparison of words, potentially improving the speed and efficiency of the similarity calculation process. In some implementations, the branched structure may be dynamically updated as new known words are added or existing words are modified, enabling the algorithm to adapt to changing document classification requirements over time.

At operation 420, for each document in the set of documents, a corresponding document category is assigned to the document in response to the first document category votes exceeding a predetermined threshold. This assignment may involve tagging the document with metadata indicating its category and other relevant information. In some implementations, the assigned document may be stored in a structured document collection corresponding to its category, facilitating efficient organization and retrieval of processed documents.

At operation 430, for each document in the set of documents, in response to the first document category votes exceeding a predetermined threshold, the document is removed from a subset of the set of input documents. The subset of the set of input documents may include documents not assigned to a document category based on the first document category votes. By removing successfully classified documents from the subset of the set of input documents, time and computing resources are conserved that would have been used by later stages of a processing funnel, such as a machine-learning architecture.

At operation 440, a machine-learning architecture is executed to assign second document category votes. These votes may be assigned to the subset of the set of input documents based on a second similarity between features of the subset of the set of input documents and features of a set of known documents. The machine-learning architecture may utilize various techniques to generate feature vectors for input documents and known documents. In some implementations, the feature vectors may include numerical representations of document characteristics such as word frequencies, term frequency-inverse document frequency (TF-IDF) scores, or embeddings generated by pre-trained language models. The feature vectors may capture both semantic and structural information about the documents.

The machine-learning architecture may be configured to determine a set of similarity scores by comparing the feature vectors of input documents with those of the known documents. In some implementations, the architecture may employ cosine similarity calculations to measure the angular distance between feature vectors in the high-dimensional space. Additionally, the system may utilize other similarity metrics such as Euclidean distance or Jaccard similarity. The machine-learning architecture may generate a similarity matrix, where each element represents the similarity score between an input document and a known document. These similarity scores may then be used to inform the assignment of document category votes, with higher similarity scores potentially corresponding to a greater number of votes for the associated category.

The machine-learning architecture may generate confidence scores for input documents based on the determined similarities between the input documents and the known documents. The machine-learning architecture may generate both cosine similarities and Jaccard similarities between the input documents and the set of known documents. The machine-learning architecture may generate a first set of similarity scores based on cosine similarities between an input document and the set of known documents. The machine-learning architecture may generate a second set of similarity scores based on Jaccard similarities between the same input document and the set of known documents. Using these two sets of similarity scores, the machine-learning architecture may generate a set of confidence scores for the input document. These confidence scores may indicate the level of confidence that the input document belongs to various document categories corresponding to the set of known documents. This multi-step similarity and confidence scoring process may allow the system to capture different aspects of document similarity, potentially improving the accuracy of document categorization.

The machine-learning architecture may assign a number of second document category votes to the subset of the set of input documents based on the set of confidence scores for each input document. In some implementations, the number of votes assigned to a particular document category may be proportional to the confidence score for that category. For example, a higher confidence score for a specific category may result in a larger number of votes being allocated to that category for the input document. The system may employ a scaling factor or normalization technique to convert confidence scores into a discrete number of votes. In some cases, the machine-learning architecture may use a threshold-based approach, where confidence scores above certain levels trigger the assignment of additional votes. This voting mechanism may allow the system to reflect the varying degrees of certainty in its classifications, potentially improving the overall accuracy of the document categorization process.

In some implementations, the method 400 may include executing an additional machine-learning architecture to assign third document category votes to a second subset of the set of input documents. This assignment of third document category votes may be based on a third similarity between features of the second subset of the set of input documents and features of the set of known documents. The additional machine-learning architecture may employ more sophisticated techniques or models compared to earlier stages, potentially allowing for improved classification of complex or ambiguous documents. This multi-tiered approach may enable the system to handle a wide range of document types and complexities, with each successive stage potentially refining the classification results for documents that were not confidently categorized in previous stages.

In some implementations, the method 400 may include, for each input document in the second subset, if the second document category votes exceed a second predetermined threshold, assigning a corresponding document category to that input document. Once a category is assigned, the input document may be removed from the second subset. This process may allow for efficient handling of documents that require more sophisticated analysis to be confidently categorized. The second subset of the set of input documents may include documents that were not assigned a document category based on the second document category votes in previous stages. By implementing this additional evaluation step, the system may further refine its categorization process, potentially improving overall accuracy and reducing the number of documents requiring further analysis in subsequent stages. By reducing the number of documents requiring further analysis in subsequent stages, time and computing resources are conserved, particularly if the subsequent stages implement more complex, more computationally expensive, and/or more time-consuming processes. In this way, reducing the number of documents requiring further analysis in subsequent stages improves the functioning of a computer used to implement the method 400 to categorize the input documents, reducing power consumption, lowering a temperature of the computer, reducing an amount of time and manual labeling of training data before generating useful results, and reducing an amount of processor time allocated to the categorization of the input documents.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a non-transitory computer-readable storage device, a non-transitory computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The processes and logic flows described in this specification can be performed by one or more programmable processors executing one or more computer programs (e.g., components of the monitoring device 102) to perform actions by operating on input data and generating an output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system comprising:
one or more processors; and
a memory storing instructions that, when executed by the one or more processors, cause the one or more processors to:
classify a set of input documents associated with a vehicle transaction into a plurality of vehicle-sale document categories using a set of algorithms arranged in a sequential processing pipeline, wherein each algorithm of the set of algorithms is configured to assign respective document category votes to input documents, and wherein each subsequent algorithm in the sequential processing pipeline is configured to classify a subset of the set of input documents not successfully classified by a preceding algorithm in the sequential processing pipeline;
for each input document classified into a vehicle-sale document category, tag the input document with metadata indicating the vehicle-sale document category;
group the classified input documents that are associated with the vehicle transaction into a structured data format organized according to the plurality of vehicle-sale document categories, the structured data format representing a deal jacket for the vehicle transaction; and
store the structured data format in a document collection database.

2. The system of claim 1, wherein the plurality of vehicle-sale document categories comprises two or more of a vehicle identification document, an inspection report, a financing agreement, warranty information, a bill of sale, an insurance verification, a registration form, and a trade-in appraisal.

3. The system of claim 1, wherein the metadata for each input document further indicates a confidence score generated during the classification and extracted information comprising at least one of a vehicle identification number (VIN) or a sale price.

4. The system of claim 1, wherein a first algorithm of the set of algorithms comprises a known words algorithm configured to assign document category votes to the input documents based on similarities between words in the input documents and a set of known words correlated with the plurality of vehicle-sale document categories.

5. The system of claim 4, wherein the set of known words comprises terms correlated with a vehicle identification document, terms correlated with a vehicle inspection report, and terms correlated with a financing document.

6. The system of claim 1, wherein classifying the set of input documents comprises determining, for at least one input document, a document category and a sub-category of the document category.

7. The system of claim 1, wherein the instructions further cause the one or more processors to implement a voting monitor configured to, after execution of an algorithm of the set of algorithms, compare a number of document category votes assigned by the algorithm to a predetermined threshold and remove, from the sequential processing pipeline, input documents for which the number of document category votes exceeds the predetermined threshold.

8. The system of claim 1, wherein the plurality of vehicle-sale document categories is specific to a particular vehicle dealership, and wherein at least one algorithm of the set of algorithms comprises a machine-learning model trained using documents labeled according to the plurality of vehicle-sale document categories by the particular vehicle dealership.

9. The system of claim 1, wherein the structured data format is configured to facilitate integration with at least one of inventory management software or customer relationship management software.

10. The system of claim 1, wherein the structured data format groups all of the classified input documents associated with the vehicle transaction such that the classified input documents for the vehicle transaction are retrievable together from the document collection database.

11. A method comprising:
classifying a set of input documents associated with a vehicle transaction into a plurality of vehicle-sale document categories using a set of algorithms arranged in a sequential processing pipeline, wherein each algorithm of the set of algorithms assigns respective document category votes to input documents, and wherein each subsequent algorithm in the sequential processing pipeline classifies a subset of the set of input documents not successfully classified by a preceding algorithm in the sequential processing pipeline;
for each input document classified into a vehicle-sale document category, tagging the input document with metadata indicating the vehicle-sale document category;
grouping the classified input documents that are associated with the vehicle transaction into a structured data format organized according to the plurality of vehicle-sale document categories, the structured data format representing a deal jacket for the vehicle transaction; and
storing the structured data format in a document collection database.

12. The method of claim 11, wherein the plurality of vehicle-sale document categories comprises two or more of a vehicle identification document, an inspection report, a financing agreement, warranty information, a bill of sale, an insurance verification, a registration form, and a trade-in appraisal.

13. The method of claim 11, wherein the metadata for each input document further indicates a confidence score generated during the classification and extracted information comprising at least one of a vehicle identification number (VIN) or a sale price.

14. The method of claim 11, wherein a first algorithm of the set of algorithms comprises a known words algorithm that assigns document category votes to the input documents based on similarities between words in the input documents and a set of known words correlated with the plurality of vehicle-sale document categories.

15. The method of claim 11, wherein classifying the set of input documents comprises determining, for at least one input document, a document category and a sub-category of the document category.

16. The method of claim 11, further comprising, after execution of an algorithm of the set of algorithms, comparing a number of document category votes assigned by the algorithm to a predetermined threshold and removing, from the sequential processing pipeline, input documents for which the number of document category votes exceeds the predetermined threshold.

17. The method of claim 11, wherein the plurality of vehicle-sale document categories is specific to a particular vehicle dealership, and wherein at least one algorithm of the set of algorithms comprises a machine-learning model trained using documents labeled according to the plurality of vehicle-sale document categories by the particular vehicle dealership.

18. The method of claim 11, wherein the structured data format is configured to facilitate integration with at least one of inventory management software or customer relationship management software.

19. The method of claim 11, wherein the structured data format groups all of the classified input documents associated with the vehicle transaction such that the classified input documents for the vehicle transaction are retrievable together from the document collection database.

20. A non-transitory computer-readable medium storing instructions that, when executed by one or more processors, cause the one or more processors to perform operations comprising:
classifying a set of input documents associated with a vehicle transaction into a plurality of vehicle-sale document categories using a set of algorithms arranged in a sequential processing pipeline, wherein each algorithm of the set of algorithms assigns respective document category votes to input documents, and wherein each subsequent algorithm in the sequential processing pipeline classifies a subset of the set of input documents not successfully classified by a preceding algorithm in the sequential processing pipeline;
for each input document classified into a vehicle-sale document category, tagging the input document with metadata indicating the vehicle-sale document category;
grouping the classified input documents that are associated with the vehicle transaction into a structured data format, organized according to the plurality of vehicle-sale document categories, that represents a deal jacket for the vehicle transaction; and
storing the structured data format in a document collection database.
